(19) United States
(12) Patent Application Publication
(10) Pub. No.: US 2008/0308505 A1
(43) Pub. Date: Dec. 18, 2008

(54) System and Process for Removal of Phosphorous and Ammonia from Aqueous Streams

(76) Inventors: Robert Jansen, Portela (PT); Sebastien Camborieux, Surrey (GB); Genevieve Kenny, Toronto (CA); Richard Tanner, Roydon (GB); Loren Luppes, Estero, FL (US); Anthony Baiada, Dagenham (GB); John Kerr, South Croydon (GB); Timothy Windebank, Melksham (GB)

Correspondence Address: WILLIAMS, MORGAN & AMERSON, 10333 RICHMOND, SUITE 1100, HOUSTON, TX, 77042, US

(21) Appl. No.: 12/047,673

(22) Filed: Mar. 13, 2008

Related U.S. Application Data
(60) Provisional application No. 60/895,165, filed on Mar. 16, 2007.

(51) Int. Cl. B01J 20/04

(52) U.S. Cl. 210/752; 210/199; 210/137

(57) ABSTRACT

We disclose a process for the removal of phosphorous and ammonia from an aqueous stream by contacting the aqueous stream with magnesium and base in a first zone having a first pH, to form an (n−1)th mixed stream and a first portion of struvite; separating the (n−1)th mixed stream from the first portion of struvite; removing at least some struvite from the first portion of struvite; contacting the (n−1)th mixed stream with base in an nth zone, wherein n is an integer incrementing from 2 to nₘₐₓ, wherein nₘₐₓ is an integer from 2 to about 5, and wherein the nth zone has an nth pH higher than the (n−1)th pH, to form an nth mixed stream and an nth portion of struvite, except no base is added and the nth pH need not be higher than the (n−1)th pH when n=nₘₐₓ; separating the nth mixed stream from the nth portion of struvite; returning the nth portion of struvite to the (n−1)th zone; and, if n<nₘₐₓ, incrementing n and repeating the second contacting, second separating, and returning steps, or, if n=nₘₐₓ, releasing the nth mixed stream to a treated water tank. We also disclose a system which can be used for performing the method.

This application claims priority from U.S. provisional patent application Ser. No. 60/895,165, filed on Mar. 16, 2007, which is incorporated herein by reference.

### BACKGROUND OF THE INVENTION

The present invention relates generally to the field of waste water treatment. More particularly, it concerns the removal of phosphorous and ammonia from aqueous streams.

Phosphorous compounds and ammonia are generated in a number of biological and industrial processes, such as refining of grains such as corn. Phosphorous compounds and ammonia have relatively low value and, in the past, have frequently been disposed of by discharge of the untreated compounds into bodies of water. However, when present in bodies of water at elevated concentrations, phosphorous and ammonia may promote algae blooms, leading to localized hypoxia of the body of water and dying off of fish. The desire to avoid algae blooms and fish kills has led to reductions in the amount of allowable discharge of phosphorous compounds and ammonia in aqueous streams.

Removal of phosphorous compounds contained in entrained solids can be performed by centrifugation or settling. However, dissolved phosphorous compounds will not be removed by those techniques. A number of techniques for removal of dissolved phosphorous are known, including removal by aerobic microbes, removal by phosphate-accumulating microbes, precipitation by iron or calcium addition, and precipitation as struvite. Removal by the use of microbes tends to require relatively expensive plant and equipment and to generate sludges of cells that are relatively difficult to handle. Precipitation by iron or calcium addition, in order to generate iron phosphates or calcium phosphates, involves the cost of the added iron and calcium compounds and processing to handle the masses of iron phosphates or calcium phosphates.

It is known that phosphorous and ammonia are components of struvite, Mg²⁺NH₄⁺PO₄³⁻.6H₂O (s), and that in principle phosphorous and ammonia could be removed from an aqueous stream by reaction with magnesium and precipitation of struvite. A number of studies have indicated that struvite precipitation in wastewater streams can take place at pH values from 6.5 to more than 10; at temperatures from about 25° C. to about 35° C.; with the use of magnesium oxide, magnesium sulfate, magnesium chloride, or magnesium carbonate as a magnesium source; with phosphate supplementation with phosphoric acid, potassium hydrogen phosphate, and potassium dihydrogen phosphate; with pH adjustment by use of lime, sodium hydroxide, or potassium hydroxide; with the use of borosilicate glass filings and sand as nucleating agents; and with optimal reaction times of about 25 min. It is also known that as the pH of a solution saturated with respect to struvite rises, the solubility of struvite falls. The art also teaches that struvite precipitation from a solution above its critical supersaturation level will form many small struvite nuclei, which, the art alleges, is undesirable. A number of struvite precipitation works for the removal of phosphorous compounds are known in Japan, the Netherlands, and the United States.

### SUMMARY OF THE INVENTION

In one embodiment, the present invention relates to a process for the removal of phosphorous and ammonia from an aqueous stream by contacting the aqueous stream with magnesium and base in a first zone having a first pH, to form an (n−1)th mixed stream and a first portion of struvite; separating the (n−1)th mixed stream from the first portion of struvite; removing at least some struvite from the first portion of struvite; contacting the (n−1)th mixed stream with base in an nth zone, wherein n is an integer incrementing from 2 to nₘₐₓ, wherein nₘₐₓ is an integer from 2 to about 5, and wherein the nth zone has an nth pH higher than the (n−1)th pH, to form an nth mixed stream and an nth portion of struvite, except no base is added and the nth pH need not be higher than the (n−1)th pH when n=nₘₐₓ; separating the nth mixed stream from the nth portion of struvite; returning the nth portion of struvite to the (n−1)th zone; and, if n<nₘₐₓ, incrementing n and repeating the second contacting, second separating, and returning steps, or, if n=nₘₐₓ, releasing the nth mixed stream to a treated water tank.

In another embodiment, the present invention relates to a system for the removal of phosphorous and ammonia from an aqueous stream containing an aqueous stream inlet, a magnesium inlet, and a first base inlet, all in fluid communication with the bottom of a first zone, where an aqueous stream, magnesium, and a base mix to form a first mixed stream; a first struvite outlet in fluid communication with the bottom of the first zone; a struvite screen in fluid communication with the first struvite outlet; a first mixed stream outlet in fluid communication with the top of the first zone; an nth base inlet, wherein n is an integer incrementing from 2 to nₘₐₓ, wherein nₘₐₓ is an integer from 2 to about 5, except there is no nth base inlet with n=nₘₐₓ; an nth zone, wherein the (n−1)th mixed stream outlet and the nth base inlet are in fluid communication with the bottom of the nth zone, the (n−1)th mixed stream and the nth base mix to form an nth mixed stream, except there is no flow of base when n=nₘₐₓ; an nth struvite outlet in fluid communication with the bottom of the nth zone and the top of the (n−1)th zone; and an nth mixed stream outlet in fluid communication with the top of the nth zone and, if n<nₘₐₓ, the bottom of an (n+1)th zone or, if n=nₘₐₓ, a treated water tank.

A problem often experienced with struvite in industrial systems (waste water treatment plants etc) is that it has a tendency to foul any surfaces that the liquid mass contacts (reactor wall surfaces, pipes, pumps etc). This fouling is a consequence of struvite's extremely low solubility as well as its tendency to self agglomerate; any struvite that sticks to the reactor surface rapidly serves as a nucleation site for significant struvite fouling (barnacles etc). A key aspect of this invention is the recirculation of seed crystals into the reacting mass. The objective, though not to be bound by theory, is to provide an overwhelming exposed surface area of struvite crystals to act as the seed for struvite deposition: this reseed concomitantly achieves two aims (a) reduced fouling on exposed reactor surfaces (b) reduced spontaneous nucleation to form fines in the liquid mass. Seeding reduces the degree of super-saturation required to precipitate struvite.

The process and the system provide rapid, efficient removal of phosphorous and ammonia from aqueous streams, such as, in some embodiments, more than 90%, such as more than 95%, removal of phosphorous and more than 80% removal of ammonia.

### DESCRIPTION OF THE DRAWINGS

FIG. 1 shows the influence of magnesium concentration and pH on the ion activity product (IAP) of struvite precipitation.

FIG. 2 represents a 4-zone/4-vessel system for phosphorous and ammonia removal, as discussed in Example 1.

FIG. 3 schematically depicts the rapid mixing of the aqueous stream, magnesium, and base performed in Example 1.

FIG. 4 reports flows around reactor 1 of Example 1.

FIG. 5 shows dimensions of the vessel and the streams into and out of the vessel of Example 2.

FIG. 6 shows the streams into and out of the vessel of Example 2.

FIG. 7 schematically shows the system used in Example 3.

FIG. 8 shows a flow chart of the process of one embodiment of the present invention.

### DESCRIPTION OF ILLUSTRATIVE EMBODIMENTS

In one embodiment, the present invention relates to a process for the removal of phosphorous and ammonia from an aqueous stream by contacting the aqueous stream with magnesium and base in a first zone having a first pH, to form an (n−1)th mixed stream and a first portion of struvite; separating the (n−1)th mixed stream from the first portion of struvite; removing at least some struvite from the first portion of struvite; contacting the (n−1)th mixed stream with base in an nth zone, wherein n is an integer incrementing from 2 to nₘₐₓ, wherein nₘₐₓ is an integer from 2 to about 5, and wherein the nth zone has an nth pH higher than the (n−1)th pH, to form an nth mixed stream and an nth portion of struvite, except no base is added and the nth pH need not be higher than the (n−1)th pH when n=nₘₐₓ; separating the nth mixed stream from the nth portion of struvite; returning the nth portion of struvite to the (n−1)th zone; and, if n<nₘₐₓ, incrementing n and repeating the second contacting, second separating, and returning steps, or, if n=nₘₐₓ, releasing the nth mixed stream to a treated water tank.

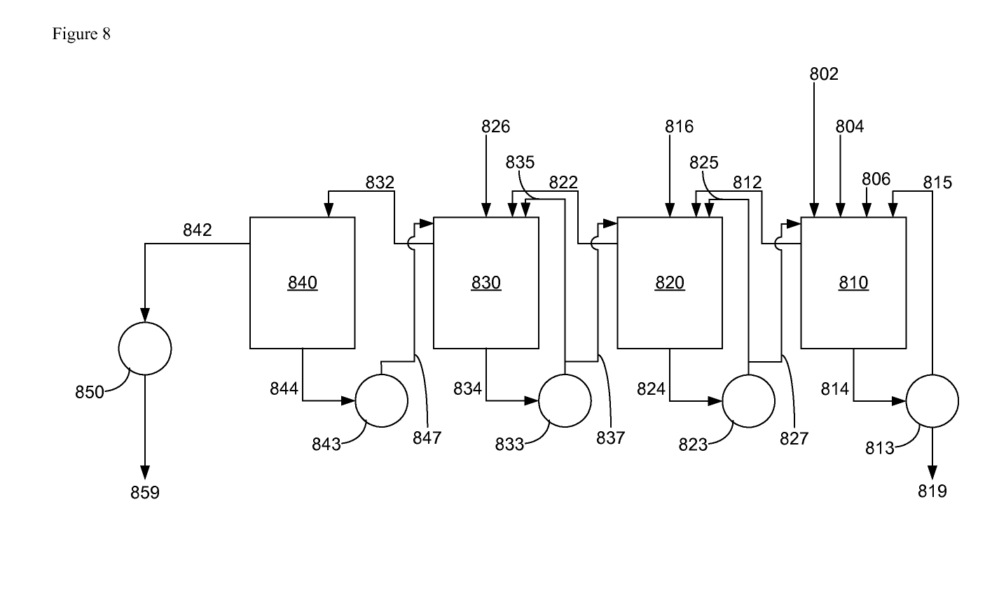

An exemplary embodiment, wherein nₘₐₓ=4, will be discussed in the context of the system schematically shown in FIG. 8. It will be understood that the invention is not limited to embodiments wherein nₘₐₓ=4.

Phosphorous refers to both organic and inorganic phosphorous compounds. Ammonia refers to molecules comprising the structure NH₃ or NH₄⁺. Although the nitrogen in the incoming waste stream can be in a variety of compounds eg: NH₃, NH₄⁺, RNH₂, RNH₃⁺, R₂NH, R₂NH₂⁺, R₃N, or R₃NH⁺, wherein each R is independently any organic or inorganic moiety, typical waste treatment involves pretreatment of these nitrogen-containing molecules in an anaerobic digester will convert the N into its ammoniacal form (NH₃, NH₄⁺), thus facilitating the capture of this nitrogen in the struvite structure. The aqueous stream can be any stream containing primarily water, with some level of phosphorous, ammonia, and possibly other materials. In one embodiment, the aqueous stream is a waste stream generated by processing of corn, wheat, oats, other grains, or soybeans (generically herein, cereals).

Magnesium refers to any compound containing Mg, such as MgCl₂, MgSO₄, or Mg(OH)₂, among others. Base refers to any material having the general formula M-OH, wherein M is an alkali metal or an alkaline earth metal and OH is hydroxide ion. It will be apparent to the skilled artisan that Mg(OH)₂ is both a magnesium compound and a base. Mg(OH)₂ can be used as either or both of the magnesium compound and the base referred to in the process.

In one embodiment, the base is NaOH. NaOH may be referred to herein as “caustic.”

In the process, the aqueous stream is contacted with magnesium and base in a first zone, to form an (n−1)th mixed stream having a first pH and a first portion of struvite. (The numbering of streams n−1, n, n+1, etc. will be discussed below). Typical aqueous streams generated in cereal processing have pH values of about 6.5 to about 7.0. In one embodiment, the first pH is from about 7.5 to about 8.0, such as about 7.7. Contacting can be affected by any technique known in the art, such as pumping the aqueous stream, an aqueous solution containing a magnesium compound, and an aqueous solution containing the base into a vessel or a zone of a vessel. In one embodiment, contacting allows rapid mixing of the aqueous stream, the magnesium, and the base. In one embodiment, contacting is performed in the bottom (i.e., in the lower two-thirds of the height) of the first zone, such as in the bottom of a vessel constituting the entire first zone or in the bottom of a first zone defined as a region of a vessel.

In FIG. 8, the aqueous stream 802 is contacted with magnesium 804 and base 806 in the first zone 810.

When phosphorous and ammonia from the aqueous stream and magnesium are mixed in the (n−1)th mixed stream, struvite will precipitate when the equilibrium ion activity product (IAP) of the following reaction is exceeded:

Mg⁽²⁺⁾+NH₄⁽⁺⁾+PO₄⁽³⁻⁾+6H₂O→MgNH₄PO₄.6H₂O(s)

The IAP for this reaction is:

IAP=[Mg²⁺]*[NH₄⁺]*[PO₄³⁻]=7.08*10⁻¹⁴

Where [Mg²⁺], etc. indicates the activity of the given species, which is approximately the molar concentration of the species.

Although in principle struvite can be recovered from such a solution, a number of complicating factors exist. First, small particles of struvite are difficult to capture, and therefore it is desirable to manipulate reaction conditions to promote growth of struvite particles, typically by nucleation on small particles formed during crystallization. Second, the quantity of magnesium mixed with the aqueous stream may desirably be chosen to optimize struvite crystallization and minimize the amount of phosphorous and ammonia which is not crystallized into struvite. Third, in order to minimize adventitious growth of struvite on exposed reactor surfaces, the reseed is a valuable aspect of this process, as described above.

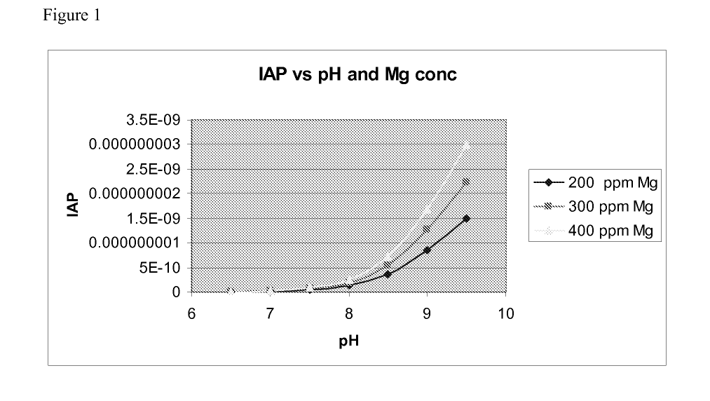

We have discovered a number of reaction conditions that can be controlled to enhance struvite production. First, [NH₄⁺] and [PO₄³⁻] are heavily pH dependent. Second, given that there are a fixed amount of two of the components (eg: ammoniacal N and orthophosphatic P), the desired IAP value to optimize struvite precipitation can be achieved by controlling the concentration of the Mg²⁺ and H⁺ concentration (pH), as shown in FIG. 1.

In one embodiment, the linear velocity of the mixed stream in the first zone is from about 0.5 m/hr to about 2.5 m/hr. Such a linear velocity allows crystals to form and grow to a size sufficient to not wash out of the first zone. For example, the residence time of the mixed stream in the first zone can be from about 10 min to about 60 min, such as about 15 min to about 30 min. In order to achieve rapid precipitation of struvite within these residence times, it is necessary for the concentrations of phosphorous, ammonia, and magnesium to significantly exceed the IAP.

In a further embodiment, the linear velocity of the mixed stream in the first zone is from about 1.5 m/hr to about 2.5 m/hr.

In one embodiment, the molar ratio Mg/P of the mixed stream in the first zone is from about 1 to about 1.4. In a further embodiment, the molar ratio Mg/P of the mixed stream in the first zone is from about 1.05 to about 1.3.

In one embodiment, the molar ratio NH₄/P of the mixed stream in the first zone is from about 1 to about 1.6. In a further embodiment, the molar ratio NH₄/P of the mixed stream in the first zone is from about 1.1 to about 1.5.

As the contacting step proceeds, the first mixed stream and the first portion of struvite in the first zone will separate, as the introduction of the aqueous stream, magnesium, and base at the bottom of the first zone will lift the first mixed stream out of the first zone, whereas particles of crystallized struvite will tend to settle out of the first mixed stream. In addition to gravity settlement and countercurrent flow, separating can involve other techniques known in the art.

After separation, a slurry containing struvite particles can be extracted from the bottom of the first zone and at least some of the struvite removed therefrom. Struvite particles of a particular size or greater can be removed by passing the slurry through a screen and subsequent removal of retained particles from the screen face, among other techniques known in the art. Removed struvite particles can be disposed of in landfill or used as a fertilizer, or alternatively, the struivte can be processed further to recover the magnesium and/or phosphoric acid. Smaller struvite particles in the slurry permeate that are not removed can be recycled to the first zone to provide nucleation or agglomeration sites for growth of struvite crystals to a size that can be removed on later performance of the removal step. It has been found desirable to have a reseed with a crystal mass in the range of about 15% to about 50% relative to the incoming feed. In other words, if the feed and reseed hydraulic volumes are 1:1, the crystal mass in the reseed stream is desirably from about 15% to about 50% by volume.

In FIG. 8, the first mixed stream 812 passes out of the first zone 810 and the struvite slurry 814 is extracted from the bottom of the first zone 810, with struvite particles of a particular size or greater being removed by screen and related flow control devices, generally, 813, for disposal 819. The slurry permeate 815 is recycled to the first zone 810.

After separation, the (n−1)th mixed stream can be contacted with base in an nth zone, wherein n is an integer incrementing from 2 to nₘₐₓ, wherein nₘₐₓ is an integer from 2 to about 5, to form an nth mixed stream having an nth pH higher than the (n−1)th pH and an nth portion of struvite. For example, the first mixed stream can be contacted with base in a second zone to form a second mixed stream having a second pH higher than the first pH and a second portion of struvite. However, no base is added and the pH of the nth mixed stream is not higher than the pH of the (n−1)th mixed stream when n=nₘₐₓ.

In FIG. 8, the first mixed stream 812 is passed to the second zone 820, where it is contacted with base 816.

As struvite forms in the earlier zones, the concentrations of phosphorous, ammonia, and magnesium will be lower in the later zones, which all else being equal would be expected to lead to reduced struvite crystallization, either by reduced formation of new nuclei or by reduced addition to existing nuclei potentially carried forward from earlier zones. We have discovered that multiple zones allow increase of the pH with decreasing concentrations of phosphorous, ammonia, and magnesium, which will tend to counteract the reduced struvite crystallization referred to above.

In the nth zone, the contacting step can proceed essentially as described above for the first zone, although the pH will be higher in the nth zone than in the (n−1)th zone, with the possible exception referred to above. If desired, changes in the zone geometry, the vessel, or other parameters can be instituted relative to the first zone contacting step, but need not be.

The linear velocity of the mixed stream in the second zone can be from about 1.5 m/hr to about 3.5 m/hr

In one embodiment, the linear velocity of the mixed stream in the final (n=nₘₐₓ) zone is from about 0.5 m/hr to about 1.5 m/hr.

To those skilled in the art, it will be apparent that it might be desirable to minimize or eliminate costs associated with pumping large volumes of liquid in these systems. If the feed inlet into any or all of these reactors is arranged such that the feed is introduced tangentially into the reactor, then the local tangential velocity can be as high as 15 m/hr, even though the vertical velocity falls within the bounds described above. By such means significant mixing/swirling can be achieved with minimal use of pumps.

As indicated above, the products of the contacting step in the nth zone are an nth mixed stream having an nth pH higher than the (n−1)th pH and an nth portion of struvite. The nth mixed stream can be separated from the nth portion of struvite essentially as described above for the first separation.

Upon separation of the nth mixed stream and the nth portion of struvite, some or all of the nth portion of struvite can be returned to the (n−1)th zone, to seed nucleation and to settle further for eventual recycle to the first zone. The nth mixed stream can be handled in one of two ways. If n<nₘₐₓ, n can be incremented and the second contacting, second separating, and returning steps can be repeated. If n=nₘₐₓ, the nth mixed stream can be released to a treated water tank, either for disposal as a material sufficiently depleted of phosphorous and ammonia to comply with disposal regulations in the local jurisdiction or for dilution with other aqueous materials to yield a diluted material which meets local requirements for phosphorous and ammonia.

In FIG. 8, the second mixed stream 822 is separated from the second portion of struvite 824 and the second mixed stream 822 is passed to the third zone 830, where it is contacted with base 826. Similarly, the third mixed stream 832 is separated from the third portion of struvite 834 and the third mixed stream 832 is passed to the fourth zone 840. Also, the second portion of struvite 824 is either returned 827 to the first zone 810, recycled 825 to the second zone 820, or both. Similarly, the third portion of struvite 834 is either returned 837 to the second zone 820, recycled 835 to the third zone 830, or both. The fourth portion of struvite 844 is returned 847 to the third zone 830. In other embodiments, recycling of the fourth portion of struvite 844 to the fourth zone 840 may be performed. Valves, pumps, or other flow control devices are represented by 823, 833, and 843.

When n=nₘₐₓ, prior to release to the treated water tank, solids can be removed from the nth mixed stream to yield a filtered nth mixed stream, followed by release of the filtered nth mixed stream to the treated water tank. The solids that can be removed include phosphorous fines, among others. Removal of solids can be effected by passing the nth mixed stream through a clarifier, thereby allowing solids to settle, or a filter, thereby allowing filtration of solids from the nth mixed stream. The vertical linear velocity in the nth zone is minimized to avoid fines carry over (target velocity 0.5-1 m/hr), and in some cases flocculants (eg: polymers) may be added to promote the formation of larger particles with less tendency to carry over. In one embodiment, removing solids from the nth mixed stream comprises filtration of solids from the nth mixed stream.

In FIG. 8, the fourth mixed stream 842 is passed to filter and flow control devices, generally, 850, where phosphorous fines can be removed and the resulting permeate can be passed to treated water tank 859.

In other words, in the embodiment shown in FIG. 8, phosphorous and ammonia compounds are removed as struvite at 816 and 819; as retentate at filter 850; and as dilute solute passed to treated water tank 859.

As should be apparent, the number of zones (nₘₐₓ) that can be used in the process can be varied. In one embodiment, there are four zones. This embodiment is not limiting.

In a further embodiment of the four-zone process, the pH of the mixed stream in the first zone is from about 7.5 to about 8.0, the pH of the mixed stream in the second zone is from about 8.2 to about 8.6, and the pH of the mixed stream in the third zone is from about 8.8 to about 9.2. Exemplary pHs are 7.7 for the first mixed stream, 8.4 for the second mixed stream, and 9.0 for the third mixed stream.

In another further embodiment of the four zone process, the linear velocity of the first, second, and third mixed streams is from about 1.5 m/hr to about 2.5 m/hr and the linear velocity of the fourth mixed stream is from about 0.5 m/hr to about 1.5 m/hr.

The zones referred to in describing this process can be either separate vessels or different regions within a single vessel. In one embodiment, two or more consecutive zones are contained within the same vessel. When consecutive zones are present in different regions of a single vessel, they will generally be arranged such that later zones of the process are higher in the vessel than earlier zones. A combination of single-zone and multi-zone vessels can be used.

In another embodiment, the present invention relates to a system for the removal of phosphorous and ammonia from an aqueous stream, comprising:

an aqueous stream inlet, a magnesium inlet, and a first base inlet, all in fluid communication with the bottom of a first zone, where an aqueous stream, magnesium, and a base mix to form a first mixed stream;

a first struvite outlet in fluid communication with the bottom of the first zone;

a struvite screen in fluid communication with the first struvite outlet;

a first mixed stream outlet in fluid communication with the top of the first zone;

an nth base inlet, wherein n is an integer incrementing from 2 to nₘₐₓ, wherein nₘₐₓ is an integer from 2 to about 5, except there is no nth base inlet with n=nₘₐₓ;

an nth zone, wherein the (n−1)th mixed stream outlet and the nth base inlet are in fluid communication with the bottom of the nth zone, the (n−1)th mixed stream and the nth base mix to form an nth mixed stream, except there is no flow of base when n=nₘₐₓ;

an nth struvite outlet in fluid communication with the bottom of the nth zone and the top of the (n−1)th zone; and an nth mixed stream outlet in fluid communication with the top of the nth zone and, if n<nₘₐₓ, the bottom of an (n+1)th zone or, if n=nₘₐₓ, a treated water tank.

The aqueous stream inlet provides fluid communication from a holding tank for the aqueous stream, via appropriate piping, pumps, and other flow control devices, to the bottom of the first zone (as defined above).

The magnesium inlet provides fluid communication from a holding tank for a magnesium-containing compound, via appropriate piping, pumps, and other flow control devices, to the bottom of the first zone. The magnesium-containing compound can be delivered to the bottom of the first zone as a slurried solid, i.e., as very fine particles in suspension, but typically will be a solute in an aqueous solution of known magnesium concentration.

The first base inlet provides fluid communication from a holding tank for a base, via appropriate piping, pumps, and other flow control devices, to the bottom of the first zone. In the event that Mg(OH)₂ is used as both a magnesium compound and a base, the magnesium inlet and the first base inlet may be the same element.

In the first zone, the aqueous stream, magnesium, and the base mix to form a first mixed stream. In the first mixed stream, the phosphorous and ammonia from the aqueous stream and the magnesium can form struvite if these materials are present at supersaturation (above the IAP). In one embodiment, the flow rate of base into the first zone can be adjusted to maintain a first pH of the first mixed stream. In one embodiment, the first pH can be from about 7.5 to about 8.0. In one embodiment, the linear velocity of the first mixed stream in the first zone is from about 0.5 m/hr to about 2.5 m/hr. In one embodiment, the molar ratio Mg/P of the first mixed stream in the first zone is from about 1 to about 1.4. In one embodiment, the molar ratio NH₄/P of the first mixed stream in the first zone is from about 1 to about 1.6.

Because struvite desirably forms in the first zone and precipitates, the system also contains a first struvite outlet in fluid communication with the bottom of the first zone, such as piping and pumps or gravity feed, and a struvite screen in fluid communication with the first struvite outlet to allow separation of struvite particles from the liquid fed from the first struvite outlet. The separated struvite particles can be disposed of or sent to alternate uses and the remaining liquid can be recycled to the top of the first zone.

The first mixed stream outlet in fluid communication with the top of the first zone, in combination with appropriate piping, pumps, other flow control devices, or other structures, allows transfer of the first mixed stream from the first zone to the second zone.

For zones n (wherein n is an integer incrementing from 2 to nₘₐₓ, wherein nₘₐₓ is an integer in the range of 2 to about 5), the nth base inlet can be substantially the same as the first base inlet described above. There need not be an nth base inlet when n=nₘₐₓ. The nth zone can be substantially the same as the first zone, with mixed stream traveling up the zone and struvite forming and precipitating to the bottom of the zone, where an nth struvite outlet can allow transfer of struvite out of the zone. In one embodiment, the flow rate of base into the nth zone can be adjusted to maintain an nth pH of the nth mixed stream. In one embodiment, the nth pH can be from about 0.4 to about 0.8 pH units higher than the (n−1)th pH. In one embodiment, the linear velocity of the mixed stream in the zones 2 to (nₘₐₓ-1) is from about 0.5 m/hr to about 2.5 m/hr. In one embodiment, linear velocity of the fourth mixed stream is from about 0.5 m/hr to about 1.5 m/hr. In one embodiment, the molar ratio Mg/P of the nth mixed stream is from about 1 to about 1.4. In one embodiment, the molar ratio NH₄/P of the nth mixed stream is from about 1 to about 1.6.

In one embodiment, the residence time of the mixed stream in each zone is from about 10 min to about 60 min, such as from about 15 min to about 30 min.

The nth struvite outlet can be similar to the first struvite outlet described above, except there need not be a screen in fluid communication with the nth struvite outlet and the outlet is in fluid communication with the bottom of the nth zone and the top of the (n−1)th zone, allowing recycle to previous zones, not the same zone as was the case for the first struvite outlet.

The mixed stream in the nth zone can then pass through the nth mixed stream outlet and through any appropriate piping, pumps, other flow control devices, or other structures from the top of the nth zone to, if n<nₘₐₓ, the bottom of an (n+1)th zone or, if n=nₘₐₓ, a treated water tank or a clarifier or filter in-line prior to the treated water tank.

In one embodiment, there are four zones (i.e., nₘₐₓ=4). When there are four zones, in a further embodiment, the pH in the first zone is from about 7.5 to about 8.0, the pH in the second zone is from about 8.2 to about 8.6, and the pH in the third zone is from about 8.8 to about 9.2. Also when there are four zones, in another further embodiment, the linear velocity of the first, second, and third mixed stream is from about 1.5 m/hr to about 2.5 m/hr and the linear velocity of the fourth mixed stream is from about 0.5 m/hr to about 1.5 m/hr. In addition, when there are four zones, in another further embodiment, the residence time of the mixed stream in each zone is from about 10 min to about 60 min.

The magnesium can be as discussed above, e.g., the magnesium can be in the form of MgCl₂, MgSO₄, or Mg(OH)₂. Also, the base can be as discussed above, e.g., the base can be in the form of NaOH or Mg(OH)₂. Mg(OH)₂ can be used as both the magnesium and the base, and it is possible that the magnesium inlet and the base inlet can be the same system element if this is the case.

The zones referred to in describing this system can be either separate vessels or different regions within a single vessel. In one embodiment, two or more consecutive zones are contained within the same vessel. When consecutive zones are present in different regions of a single vessel, they will generally be arranged such that later zones of the system are higher in the vessel than earlier zones. Also, the inner diameter of different zones of a multi-zone vessel can be larger for later zones, such as by use of an inverted-conical or stepped-diameter tank. When two or more consecutive zones are contained within the same vessel, in one embodiment, any fluid communication between two consecutive zones of the two or more consecutive zones occurs across the inner diameter of the vessel, e.g., when the (n−1)th and nth zones are in the same vessel, the (n−1)th mixed stream outlet and the nth struvite outlet may both be the entire inner diameter of the vessel containing the two zones and not separate system elements. The system can contain a combination of single-zone and multi-zone vessels can be used.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

### Example 1

### Synthetic Waste Streams—4-Zone/4-Vessel System

Background

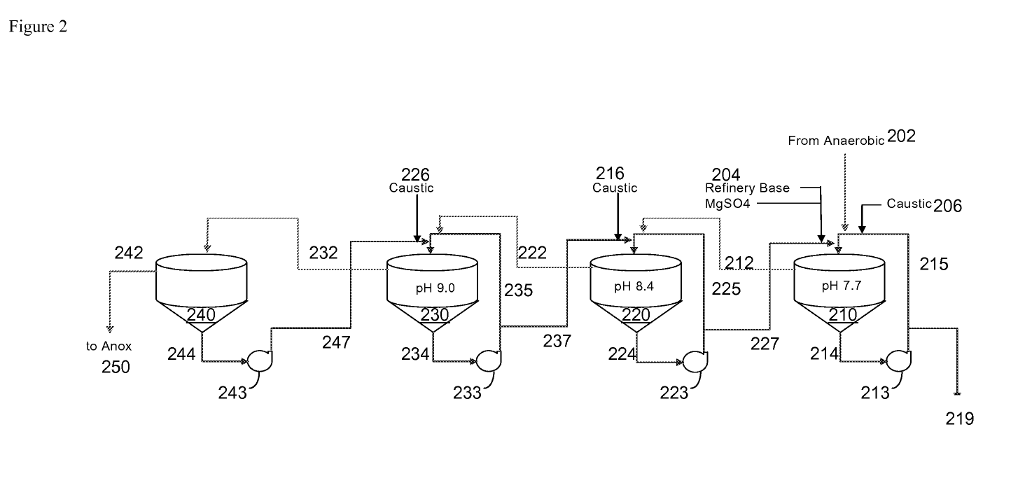

In this example, a synthetic feed stream containing 500 ppm of NH₄⁺ and 433 ppm of phosphorous was dosed with 590 ppm of Mg (added in the form of MgSO₄). The experimental set up is shown in FIG. 2.

Methodology

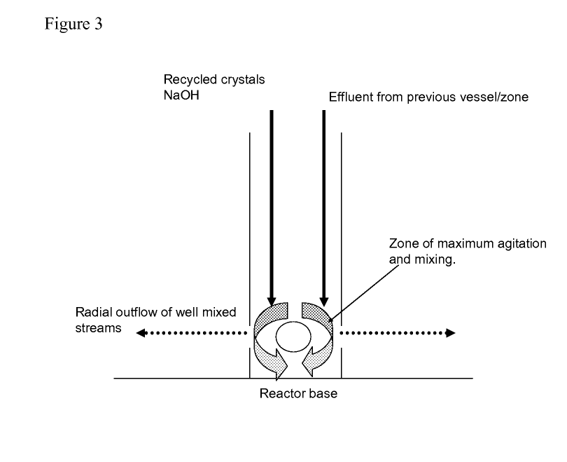

The synthetic feed stream was fed into reactor 210 at its base. Concomitantly, the MgSO₄ solution 204 and caustic base 206 were dosed into the same reaction zone to achieve maximum mixing of these three streams (see FIG. 3). The flow of caustic was controlled to meet a target pH of 7.7. A recycle loop 214, 213, 215 within reactor 210 was used to establish equilibrium in the series of reactors—once the whole system had reached steady state, this recycle loop could be diverted to a screen to capture 219 the struvite crystals formed.

Overflow from reactor 210 was allowed to pass to the second reactor 220, where the same reactor design enabled efficient mixing of this stream with more caustic 216—the target pH in this case being 8.4. Again internal recycle 224, 223, 225 within reactor 220 was maintained until recycle from reactor 220 could be sent back 227 to reactor 210. The recycle contained struvite crystals.

Overflow from reactor 220 was allowed to pass to the third reactor 230, where, again, efficient mixing of this stream with more caustic 226 was achieved in the basal zone—the target pH in this case being 9. Internal recycle 234, 233, 235 within reactor 230 was maintained until the recycle stream from reactor 230 could be sent back 237 to reactor 220.

Finally, the overflow from reactor 230 was sent to reactor 240, where any larger crystals would settle and could be recycled to reactor 230. The overflow 242 from reactor 240 was the product stream. The linear velocity in reactor 240 was controlled to minimize the amount of fines in the overflow. Measurement of the fines indicated that a target flow of 1-1.2 m/hr in reactor 240 was sufficiently low to minimize the amount of fines in the overflow 242.

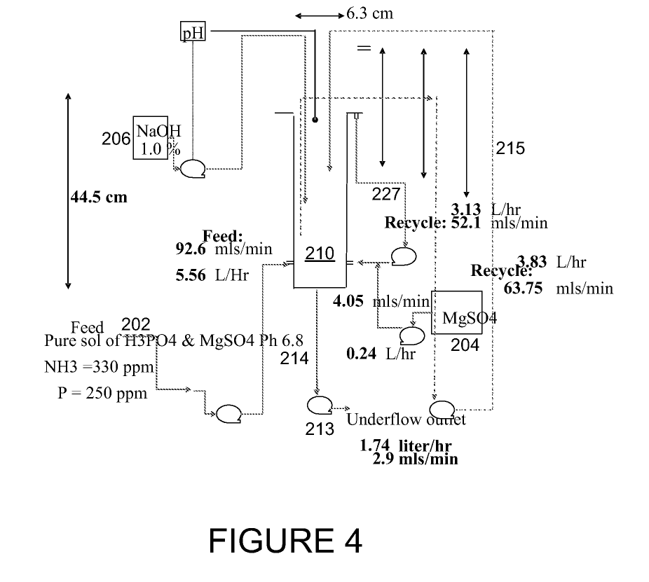

In this case, each reactor had the same dimensions: the flows around reactor 210 are shown in FIG. 4.

Results

| Component | Influent/ppm | Effluent/ppm | % removal |
|---|---|---|---|
| P | 433 | 6-10 | 97-98 |
| NH₄⁺ | 500 | | — |
| Mg²⁺ | 590 | | Not applicable |

Conclusion/Discussions

Efficient removal of both phosphorous and ammonia could be achieved by controlling the pH profile across a number of reactors in series.

### Example 2

### Waste Streams from a Corn Refinery Waste Water Treatment Process—1 Vessel System

Background

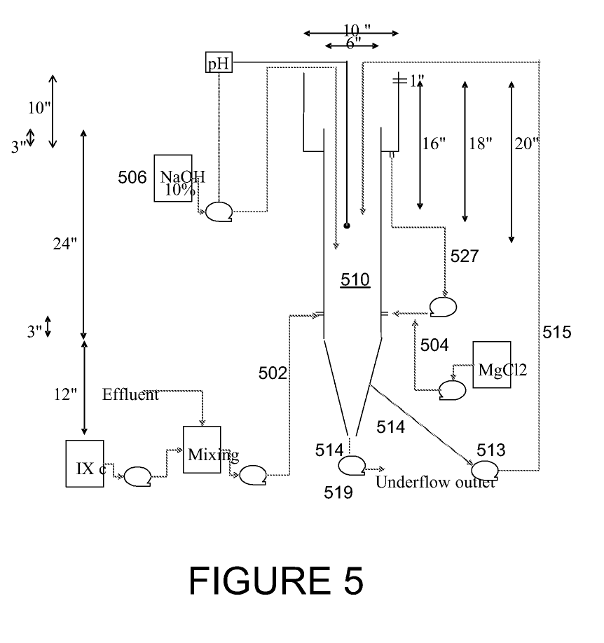

In this example, the conditions required to achieve optimal phosphorous removal were established in one reaction vessel. The dimensions of the vessel 510 and the streams into and out of the vessel are shown in FIG. 5.

Experimental

The incoming stream 502 contains a molar excess of ammonium and phosphorous. To achieve the supersaturation conditions required to make struvite, it was necessary to supplement the amount of Mg ions in the reactor. This was done by feeding a stream 504 of MgCl₂ under controlled conditions such that the excess Mg exiting in the final stream was minimized.

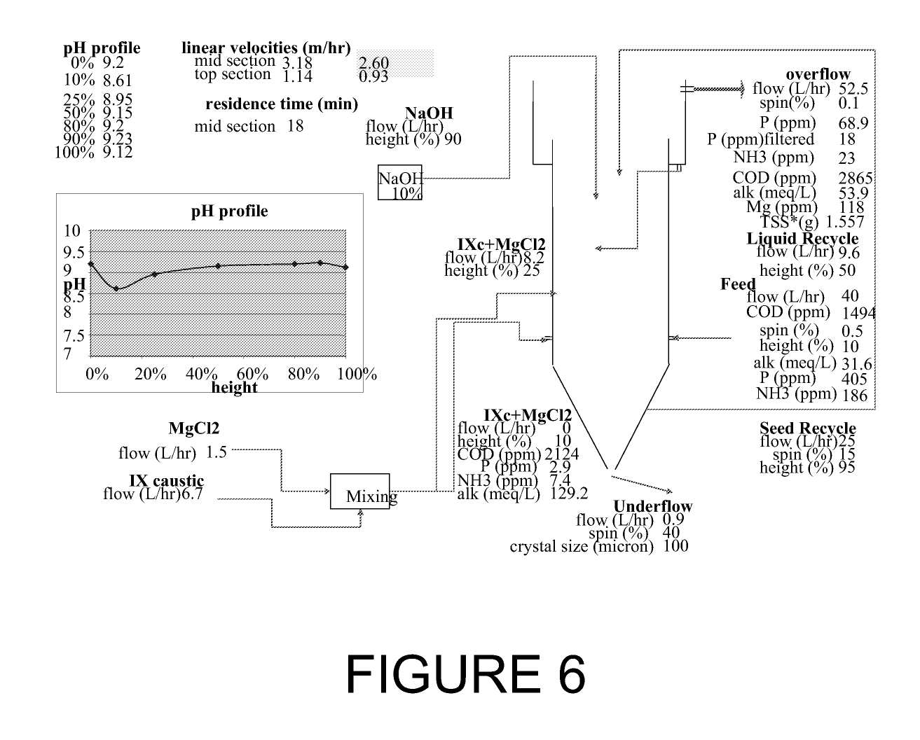

The pH profile across the reactor was established using two streams. One of these streams was caustic ion exchange waste (a medium-high pH waste stream from the corn refinery). This stream was mixed with the MgCl₂ and injected into the reactor at a height of 25%. The other high pH stream was a virgin 10% NaOH stream 502 which was fed towards the top of the reactor (90% height) under pH control to achieve the required upper end pH (pH 8.9). The pH profile established across the height of the reactor is shown in FIG. 6, where 0% represents the base of the reactor and 100% is the top.

Results

| Component | Influent/ppm | Effluent/ppm | % removal |
|---|---|---|---|
| P | 405 | 18 | 94 |
| NH₄⁺ | 186 | 23 | 83 |
| Mg²⁺ | 300 | 118 | Not applicable |

Conclusion/Discussions

As shown by the above results, the phosphorous removal was 95%. This represents excellent removal of phosphorous such that the ultimate environmental requirements of the effluent stream (discharge to a typical US municipality waste water treatment plant) can be met.

### Example 3

### Waste Streams from a Corn Refinery Waste Water Treatment Process—2 Vessel System

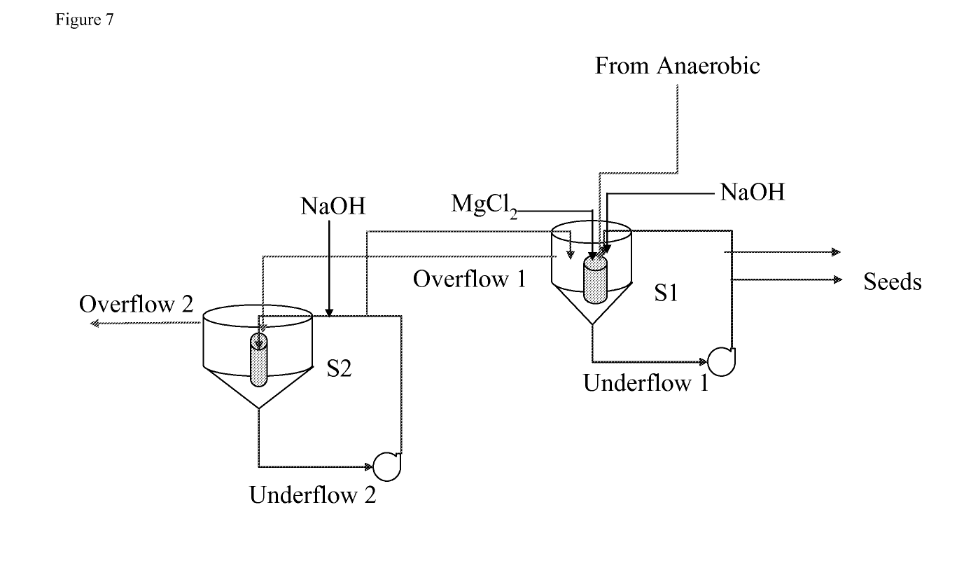

The apparatus, consisting of two reactors (S1 and S2), was set up as shown in FIG. 7. Physical parameters of S1 and S2: diameter 6 in, height 12 in, volume 1.47 gal. A typical run was characterized by (S1) Hydraulic Residence Time (HRT) 9.1 min and velocity 2.00 m/hr and (S2) HRT 8.7 min and velocity 2.11 m/hr. Overflow 2 led to an optional filter, not shown.

The feed to S1 was the product stream from an anaerobic digester (27 L/hr, 0.3 wt % solids, 417 ppm P, 263 ppm NH₃). This feed was mixed with a dilute NaOH (0.4% soln, 8.4 L/hr) stream in a mixing section in S1, along with a solution of MgCl₂ (1.1 L/hr). The pH in S1 was 7.8-8. The underflow from S1 (spin test solids content=15%) was circulated at a rate of 33 L/hr, with 0.5 L/hr of struvite particles being drawn off. The struvite crystals are separated from the recycle stream by passing the whole through a screen.

The overflow stream from S1 (36 L/hr) was fed to S2. Overflow 1 contained about 78 ppm of P (about 11 ppm of which was soluble), 60.5 ppm of NH₃, and an overall 0.2% solids. This stream was mixed with a further 2 L/hr of 0.4% NaOH, in order to control the pH in S2 to 8.8-9.0. The underflow of S2 was recirculated at a rate of 33 L/hr (spin test solids of this stream was about 5%). 0.27 L/hr of seeds was fed back into S1.

The product stream exiting S2 (33 L/hr) contained (in this case) 557 ppm of Mg, 39 ppm of total P (of which 4 ppm was soluble), and 52 ppm of NH₃. The overflow stream was 0.1% solids. When the overflow stream was filtered, this represented about 99% removal of P. Unfiltered, there was 91% removal of P.

All of the compositions and articles disclosed and claimed herein can be made and executed without undue experimentation in light of the present disclosure. While the compositions and methods of this invention have been described in terms of preferred embodiments, it will be apparent to those of skill in the art that variations may be applied to the compositions and articles described herein without departing from the concept, spirit and scope of the invention. More specifically, it will be apparent that certain agents which are both chemically and physiologically related may be substituted for the agents described herein while the same or similar results would be achieved. All such similar the spirit, scope and concept of the invention as defined by the appended claims.

What is claimed is:

1. A process for the removal of phosphorous and ammonia from an aqueous stream, comprising:
contacting the aqueous stream with magnesium and base in a first zone, to form an (n−1)th mixed stream having a first pH and a first portion of struvite;
separating the (n−1)th mixed stream from the first portion of struvite;
removing at least some struvite from the first portion of struvite;
contacting the (n−1)th mixed stream with base in an nth zone, wherein n is an integer incrementing from 2 to nₘₐₓ, wherein nₘₐₓ is an integer from 2 to about 5, to form an nth mixed stream having an nth pH higher than the (n−1)th pH and an nth portion of struvite, except no base is added and the nth pH need not be higher than the (n−1)th pH when n=nₘₐₓ;
separating the nth mixed stream from the nth portion of struvite;
returning the nth portion of struvite to the (n−1)th zone; and
if n<nₘₐₓ, incrementing n and repeating the second contacting, second separating, and returning steps, or
if n=nₘₐₓ, releasing the nth mixed stream to a treated water tank.

2. The process of claim 1, wherein nₘₐₓ=3.

3. The process of claim 2, wherein the linear velocity of the first and second mixed streams is from about 0.5 m/hr to about 2.5 m/hr, the molar ratio Mg/P of the first and second mixed streams is from about 1 to about 1.4, and the molar ratio NH₄/P of the first and second mixed streams is from about 1 to about 1.6.

4. The process of claim 2, wherein the pH of the first mixed stream is from about 7.5 to about 8.0 and the pH of the second mixed stream is from about 8.2 to about 9.

5. The process of claim 2, wherein the linear velocity of the first and second mixed streams is from about 1.5 m/hr to about 2.5 m/hr and the linear velocity of the third mixed stream is from about 0.5 m/hr to about 1.5 m/hr.

6. The process of claim 2, wherein the residence time of the mixed stream in each zone is from about 10 min to about 60 min.

7. The process of claim 2, wherein the magnesium is in the form of MgCl₂, MgSO₄, or Mg(OH)₂.

8. The process of claim 2, wherein the base is in the form of NaOH or Mg(OH)₂.

9. The process of claim 2, wherein two or more consecutive zones are contained within the same vessel.

10. The process of claim 1, wherein the releasing step comprises removing solids from the nth mixed stream, to yield a filtered nth mixed stream, followed by release of the filtered nth mixed stream to the treated water tank.

11. The process of claim 10, wherein removing solids from the nth mixed stream comprises allowing solids to settle or filtration of solids from the nth mixed stream.

12. The process of claim 11, wherein removing solids from the nth mixed stream comprises filtration of solids from the nth mixed stream.

13. A system for the removal of phosphorous and ammonia from an aqueous stream, comprising:
an aqueous stream inlet, a magnesium inlet, and a first base inlet, all in fluid communication with the bottom of a first zone, where an aqueous stream, magnesium, and a base mix to form a first mixed stream;
a first struvite outlet in fluid communication with the bottom of the first zone;
a struvite screen in fluid communication with the first struvite outlet;
a first mixed stream outlet in fluid communication with the top of the first zone;
an nth base inlet, wherein n is an integer incrementing from 2 to nₘₐₓ, wherein nₘₐₓ is an integer from 2 to about 5, except there is no nth base inlet when n=nₘₐₓ;
an nth zone, wherein the (n−1)th mixed stream outlet and the nth base inlet are in fluid communication with the bottom of the nth zone, the (n−1)th mixed stream and the nth base mix to form an nth mixed stream, except there is no flow of base when n=nₘₐₓ;
an nth struvite outlet in fluid communication with the bottom of the nth zone and the top of the (n−1)th zone; and
an nth mixed stream outlet in fluid communication with the top of the nth zone and, if n<nₘₐₓ, the bottom of an (n+1)th zone or, if n=nₘₐₓ, a treated water tank.

14. The system of claim 13, wherein the flow rate of base into the first zone is adjusted to maintain a first pH of the first mixed stream, the linear velocity of the first mixed stream in the first zone is from about 0.5 m/hr to about 2.5 m/hr, the molar ratio Mg/P of the first mixed stream in the first zone is from about 1 to about 1.4, and the molar ratio NH₄/P of the first mixed stream in the first zone is from about 1 to about 1.6.

15. The system of claim 14, wherein the flow rate of base into the nth zone is adjusted to maintain an nth pH of the nth mixed stream which is higher than the (n−1)th pH, the linear velocity of the nth mixed stream in the nth zone is from about 0.5 m/hr to about 2.5 m/hr, the molar ratio Mg/P of the nth mixed stream is from about 1 to about 1.4, and the molar ratio NH₄/P of the nth mixed stream is from about 1 to about 1.6.

16. The system of claim 15, wherein nₘₐₓ=3.

17. The system of claim 16, wherein the first pH is from about 7.5 to about 8.0 and the second pH is from about 8.2 to about 9.

18. The system of claim 16, wherein the linear velocity of the first and second mixed streams is from about 1.5 m/hr to about 2.5 m/hr and the linear velocity of the third mixed stream is from about 0.5 m/hr to about 1.5 m/hr.

19. The system of claim 16, wherein the residence time of the mixed stream in each zone is from about 10 min to about 60 min.

20. The system of claim 16, wherein the magnesium is in the form of MgCl₂, MgSO₄, or Mg(OH)₂.

21. The system of claim 16, wherein the base is in the form of NaOH or Mg(OH)₂.

22. The system of claim 16, wherein two or more consecutive zones are contained within the same vessel and any fluid communication between two consecutive zones of the two or more consecutive zones occurs across the inner diameter of the vessel.

23. The system of claim 13, further comprising a clarifier or a filter between and in fluid communication with the nₘₐₓth mixed stream outlet and the treated water tank.
